(19) United States
(12) Patent Application Publication
(10) Pub. No.: US 2016/0269329 A1
(43) Pub. Date: Sep. 15, 2016

(54) AUTOMATED LARGE FILE PROCESSING WITH EMBEDDED VISUAL CUES

(71) Applicant: Dell Software, Inc., Round Rock, TX (US)

(72) Inventor: Tomas Willis, Madison, WI (US)

(21) Appl. No.: 14/645,129

(22) Filed: Mar. 11, 2015

(51) Int. Cl. H04L 12/58; H04L 29/08

(52) U.S. Cl. CPC H04L 51/08; H04L 51/22; H04L 67/1097

(57) ABSTRACT

A network-based solution for automatically processing large email attachments or other files during migration and archiving operations may involve downloading mailboxes from a source email platform and inspecting the mailboxes for emails containing attachment files. The solution may involve uploading a copy of the detected attachment to a storage server when a comparison determines that the file size of the detected attachment file exceeds a predetermined size limit. The solution may involve modifying the email by replacing the detected attachment with a link to the copy of the detected attachment stored at the storage server. Modifying the email may also involve generating a visual cue of the detected attachment and embedding the generated visual cue into the email.

### BACKGROUND

1. Field of the Disclosure

The present disclosure concerns file migration and archiving solutions involving email platforms and other platforms (e.g., enterprise social networking platforms). More particularly, the present disclosure relates to a network-based solution for automatically processing large email attachments or other large files during migration and archiving operations and providing visual cues about the migrated or archived files.

2. Description of the Related Art

Today, businesses create, deliver, and receive email on an unprecedented level. Many businesses provide each employee with a personalized email account and dedicated mailbox within an enterprise email platform. As businesses continue to shift toward cloud-based or “hosted” email platforms such as Office 365™ offered by Microsoft, Inc. (Redmond, Wash.), migrations between email platforms have become commonplace. And yet, such migrations continue to present a host of problems and difficulties. Given the sheer quantity and size of mailboxes and emails in use today, from small businesses with only a handful of registered email accounts to Fortune 500 companies with tens of thousands of registered accounts, businesses are struggling with the fact that migrating between email platforms can be expensive, time-consuming, tedious, and error-prone.

Although automated email migration solutions like OnDemand Migration for Email™ from Dell Software Inc. (Round Rock, Tex.) have provided businesses with significantly enhanced tools for automatically migrating between email platforms, one problem in particular has persisted in the industry—dealing with large email attachments. Modern day emails regularly include attachment files such as word processing documents, spreadsheets, or images. In some instances, attachments can carry massive file sizes (e.g., when attempting to send a high-resolution image or a massive data spreadsheet). Architects and other users who routinely send large email messages or attachment files (e.g., CAD files) are particularly susceptible to experiencing these problems. Within the migration context, many hosted email platforms deal with large email attachments by enforcing a predetermined limit on the size of an attachment that may reside in the platform. While businesses face no shortage of options when selecting an email platform, not all platforms enforce the same attachment size limits. Office 365, for example, enforces an email attachment cap of 50 MB. Other email platforms enforce more liberal attachment limits of 70 MB or even 100 MB.

When two email platforms contain different attachment size limits, migrating between them presents a significant problem. Take, for example, the common scenario in which a business decides to migrate to Office 365 after using hypothetical “Source Platform” for many years. The attachment size limit for Source Platform may be 10 MB, while attachment size limit for Office 365 is only 50 MB. Having used Source Platform for many years, the business may have had thousands of its employees, each with their own dedicated mailbox, sending and receiving emails with attachments that were below Source Platform's 100 MB limit but will now violate Office 365's lower 50 MB limit. In this common scenario, the migration process will ultimately fail or—at best—be characterized by poor data fidelity as emails with attachments above 50 MB are lost or migrated without their attachments. Given these issues, businesses are unable to reliably preserve their data when migrating between certain hosted email platforms. This significant problem has persisted in the industry despite previously attempted solutions.

One inadequate approach is to identify large attachments in the source platform prior to migration and then either delete the attachments or manually move them to an alternate target platform to avoid causing failures during migration. That approach, however, requires significant manual effort and inevitably results in lost data due to human error or, at a minimum, a broken association between the attachment and the original message.

Another inadequate approach some have attempted involves reporting. During the migration, large attachments are identified and simply logged as errors for any instances in which the migration process fails to successfully transfer the attachments to the target platform. The reporting method suffers from many of the same limitations as the manual approach described above. At best, the reporting provides businesses with a method of tracking which files they must go back and manually migrate to another location. Notably, many solutions that leverage this approach also fail to offer any guidance on how to preserve data fidelity or maintain the association between the removed attachment and the original message.

Solutions like AttachThis™ and DropThis™ from Dell Software Inc. have proven useful for reducing the number of attachments maintained in an email platform, but they cannot be applied to automated migration processes. AttachThis and DropThis are add-ins for Microsoft Outlook that automatically upload email attachments to SharePoint, a hosted storage platform, rather than transmit them via email. The add-ins also insert a links that direct users to uploaded attachments stored in Microsoft SharePoint™. In addition to being unsuitable for use during migration between email platforms, AttachThis and DropThis require every individual email user to download and install the add-ins on his or her local client. As a result, the solutions are difficult to uniformly adopt or implement across an entire enterprise email platform. The same limitations significantly diminish the utility of a similar yet open-sourced mail filtering tool called MIMEDefang. In addition to being unsuitable for automated migration processes, MIMEDefang also lacks the security features and other functionality necessary to make it serviceable on an enterprise-level.

Previously attempted solutions also provide limited contextual information about migrated email attachments or other files. As a result, users are forced to make an educated guess as to the contents of any given attachment based on limited contextual information such as the file extension or any brief accompanying text. Faced with those restrictions, most users cannot quickly determine whether the content of the attachment is relevant or important. Instead, users must individually open each attachment to assess its relevancy or importance—a process that is not only laborious and inefficient for the user, but is also wasteful of the limited computing resources of the user computing device, the email platform, the hosted storage platform, and the network in general.

In addition to email platforms like those discussed above, other types of platforms, such as enterprise social networking platforms are also becoming increasingly popular. Two examples of popular enterprise social networking platforms include Jive™ offered by Jive Software (Palo Alto, Calif.) and Yammer™ offered by Yammer, Inc. (San Francisco, Calif.). The same problems discussed above apply equally with respect to these social networking platforms, which—like many hosted email platforms—enforce predetermined limitations on the size of files that may reside within the platform. Yammer, for instance, enforces a 50 MB limitation on file sizes.

The unprecedented level of email and other files generated by modern businesses has also given rise to various archiving solutions. Archiving solutions typically transfer data that is aged or infrequently accessed from a primary storage location to a less expensive secondary storage location. Current archiving solutions provide limited contextual information about archived emails or other files.

Given the foregoing, businesses continue to need easy-to-implement migration and archiving solutions that not only offer enhanced convenience, data fidelity, and security, but are also suitable for automatically handling platforms used by large pools of employees on an enterprise-level scale.

### SUMMARY OF THE CLAIMED INVENTION

A network-based solution for automatically processing large email attachments other large files during migration and archiving operations is disclosed.

In one claimed embodiment, a system for automatically processing large email attachments during migration and archiving operations may include a first email platform hosted by a first computing device. The first email platform may store a plurality of mailboxes and each mailbox may include a plurality of emails. The system may also include a storage server and an application server communicatively coupled to the first email platform and the storage server by a network. The application server may have a predetermined attachment size limit and an executable application stored in memory.

When executed by a processor of the application server, the application may download the mailboxes from the first email platform, inspect each downloaded mailbox for an email containing an attachment file, and determine a file size of a detected attachment file. The application may further compare the file size of the detected attachment file to the predetermined attachment size limit and upload a copy of the detected attachment to the storage server to be stored when the comparison determines that the file size of the detected attachment file exceeds the predetermined attachment size limit stored in memory. The application may also generate a visual cue of the detected attachment. The application may then modify the email by replacing the detected attachment in the email with a link to the copy of the detected attachment stored at the storage server. Modifying the email may also include embedding the visual cue of the detected attachment in the email. Having modified the email, the application may then transmit the modified email to at least one of the first email platform or a second email platform hosted by a second computing device communicatively coupled to the network.

In another claimed embodiment, a method for automatically processing large email attachments during migration and archiving operations may include downloading numerous mailboxes from a first email platform. The method may include inspecting each downloaded mailbox for an email containing an attachment file, determining a file size of any detected attachment file, and comparing the file size of the detected attachment file to a predetermined attachment size limit. The method may further include uploading a copy of the detected attachment to a storage server for storage when the comparison determines that the file size of the detected attachment file exceeds the predetermined attachment size limit. A visual cue of the detected attachment may also be generated. The method may also include modifying the email by replacing the detected attachment in the email with a link to the copy of the detected attachment stored at the storage server and then transmitting the modified email to the at least one of the first email platform or a second email platform hosted by a second computing device communicatively coupled to the network. Modifying the email may also include embedding the visual cue of the detected attachment in the email.

In yet another claimed embodiment, a non-transitory computer-readable storage medium may store an executable computer program that, when executed by a processor, may perform the foregoing method for automatically processing large email attachments or other large files during migration and archiving operations. The migrated or archived documents may include visual cues of any attachments or other large files replaced with links to remotely stored copies.

### BRIEF DESCRIPTION OF THE FIGURES

FIG. 1 is a block diagram of an exemplary environment in which a network-based solution for automatically processing large email attachments or other large files during migration and archiving operations may function.

FIG. 2 is a block diagram of an exemplary application.

FIG. 3 is a flow diagram of an exemplary method for automatically processing large email attachments or other large files during migration and archiving operations.

FIG. 4 is an illustration of an exemplary email with a stubbed attachment file.

FIG. 5A is an illustration of an exemplary stub without a visual cue of the content contained in the stubbed attachment file of FIG. 4.

FIG. 5B is an illustration of an exemplary sub with a visual cue of the content contained in the stubbed attachment file of FIG. 4.

FIG. 6 is a block diagram of an exemplary system for implementing a computing device.

### DETAILED DESCRIPTION

A network-based solution for automatically processing large email attachments or other large files during migration and archiving operations is disclosed. Although the novel solution is illustrated in this disclosure by way of various exemplary systems and methods, it should be understood that the embodiments described herein are exemplary only and are in no way limiting. For instance, although certain portions of the present disclosure discuss migrating emails between email platforms, the described solution applies equally to migrating other files across such platforms, such as calendar items, task or “to do” items, contacts, etc. Moreover, although the figures provided illustrate one illustrative embodiment as applied to migrations between email platforms, the solution also offers the same benefits with respect to migrations between other types of platforms, such as enterprise social networking platforms (e.g., from Jive to Yammer). Similarly, the solution is equally applicable to archiving operations. Thus, any use of migration operations as an illustrative example should not be construed as limited to those types of operations. Persons of ordinary skill in the art will readily recognize and appreciate that the present disclosure suggests many other possible embodiments in addition to those expressly described herein.

The network-based solution for automatically processing large email attachments or other large files during migration and archiving solutions, as may be embodied by various systems, methods, and non-transitory computer-readable storage media, may involve downloading one or more mailboxes from a source email platform and inspecting the mailboxes for emails containing attachment files. In the exemplary case of migrating between email platforms, the attachment files may be text documents, spreadsheets, slide decks, videos, images, or any other file type transmittable by email. The solution may involve determining a file size of any detected attachment, comparing the file size of the detected attachment file to a predetermined attachment size limit, and uploading a copy of the detected attachment to a storage server for storage when the comparison determines that the file size of the detected attachment file exceeds the predetermined attachment size limit. The solution may involve generating a visual cue of the detected attachment. The solution may further include modifying the email by replacing the detected attachment with a link to the copy of the detected attachment stored at the storage server and then migrating the modified email to the target email platform. Modifying the email may also include embedding the visual cue of the detected attachment in the email. The modified email may then be migrated to the target email platform, which may include performing any conversions necessary for the modified email to be accepted by the target email platform.

In another embodiment concerning migration from a source enterprise social networking platform to a target enterprise social networking platform, the network-based solution may involve downloading user profiles, business unit groups, or other organized compartments of data and inspecting the same for the presence of large files. The solution may involve determining a file size of any detected file, comparing the file size of the detected file to a predetermined file size limit, and uploading a copy of the detected file to a storage server for storage when the comparison determines that the size of the detected file exceeds the predetermined attachment size limit. The solution may further include modifying the user profile, business unit group, or other organized compartment of data designated for migration by replacing the detected file with a link to the copy of the detected file at the storage server and then migrating the modified user profile, business unit group, or other organization compartment of data to the target enterprise social networking platform. The solution may also involve generating a visual cue of the detected file and embedding the visual cue in the email before migrating the file to the target platform.

In yet a further embodiment, the solution may be implemented within the context of archiving operations. During an archiving operation, the solution may involve downloading email, social media files (e.g., user profiles), business unit groups, or other types of data and inspecting the same for the presence of large files. The solution may involve determining a file size of any detected file, comparing the file size of the detected file to a predetermined file size limit, and uploading a copy of the detected file to a storage server for storage when the comparison determines that the size of the detected file exceeds the predetermined attachment size limit. The solution may include modifying the email, social media files, business unit group, or other data designated for archiving by replacing the detected file with a link to the copy of the detected file at the storage server. In doing so, the solution may allow administrators or users to reduce the disk usage and other computing resources consumed at a primary computing device (e.g., a primary email server) by transferring large files to a secondary storage location (e.g., a SharePoint server or a secondary email server). The solution may further involve generating a visual cue of the detected file and embedding the visual cue in the modified email or other file that remains on the primary computing device.

The network-based solution described herein constitutes a significant advancement in the migration and archiving fields, particularly with respect to enterprise-scale migrations between email platforms and other platforms (e.g., social networking platforms) and enterprise-scale archiving operations. As discussed below in further detail, the solution overcomes a persistent problem in the email and file storage industries by automatically processing large email attachments or other files that, absent the solution, cannot be successfully migrated or archived due to attachment limits inherent in a target email platform or secondary storage archive. The solution overcomes the same issues with respect to other types of platforms, as noted above. The solution not only ensures greater data fidelity during migration and archiving operations, but it also offers data security benefits and is easy to deploy and use. The solution is also suitable for use by multiple employees on an enterprise-level scale and, in some embodiments, provides enhanced convenience through the display of visual cues of processed attachments or other large files.

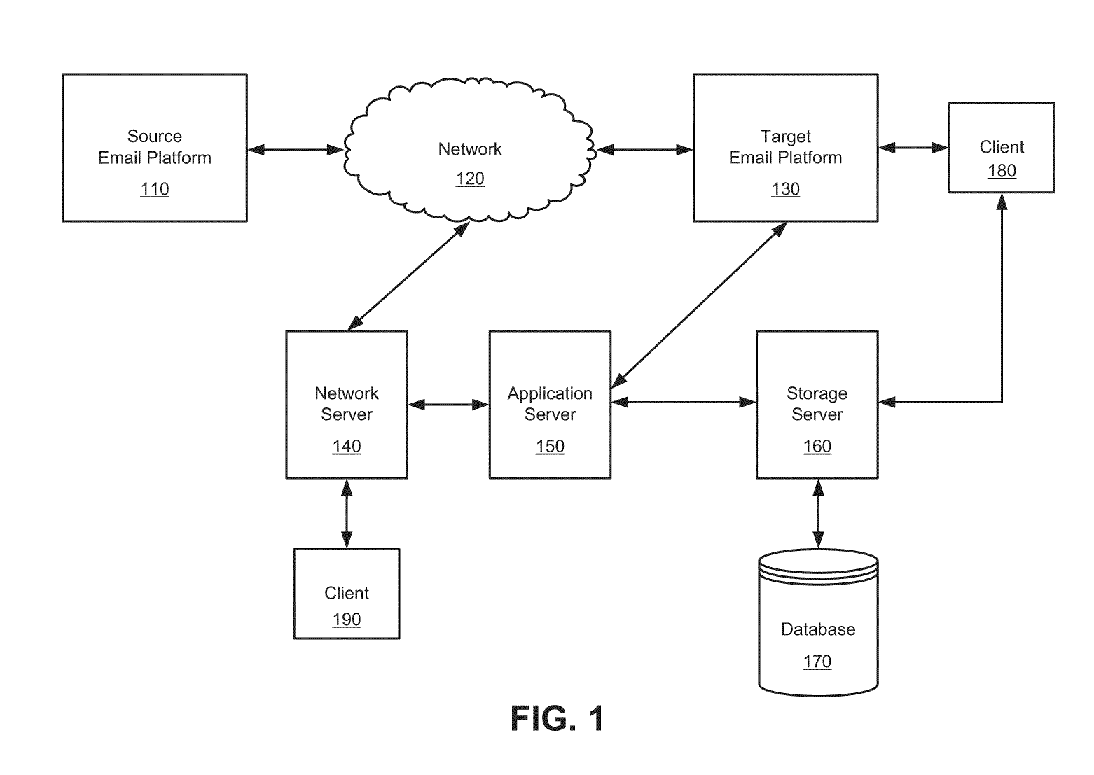

FIG. 1 is a block diagram of an exemplary environment 100 in which a network-based solution for automatically processing large email attachments or other large files during migration and archiving operations may function. Although FIG. 1 is presented in the context of migration between email platforms, in alternative embodiments the network-based solution provides for automatic processing of large files during migration between other types of platforms, such as enterprise social networking applications. Additionally, in other embodiments the solution provides for automatic processing of large attachments or other large files during archiving operations (e.g., where the large file is transferred from a primary email server or other primary storage location to a secondary storage location to reduce disk usage and other computing resources consumed at the primary storage location). Accordingly, although certain figures have been presented for the purpose of illustration, they should not be construed as limited to the precise forms disclosed. By way of an example, where FIG. 1 discusses a “source email platform” or “target email platform,” it should be understood that the described embodiment is exemplary and that, in other possible embodiments, the structures described could alternatively be a source enterprise social networking platform and target enterprise social networking platform, respectively, or other types of platforms. Similarly, inspected “mailboxes” could, in other embodiments, be user profiles, posts, storage systems, and so forth that are inspected directly for large files. In embodiments concerning archiving operations, the environment may optionally omit a target platform like that shown in FIG. 1. In such cases, the modified email or other file may be stored back on the primary storage device as opposed to being migrated to a target platform as described within the context of FIG. 1. Persons of ordinary skill in the art will readily recognize and appreciate that the solution described herein may be implemented in a variety of contexts (e.g., migration and archiving solutions) and that the provided description and figures are illustrative and are in no way limiting.

As shown in FIG. 1, one exemplary environment may include a source email platform 110 communicatively coupled to a communications network 120. The source email platform 110 may be communicatively coupled to a target email platform 130 through network 120 and numerous intermediate computing devices, such as a network server 140. Network server 140 may be communicatively coupled to an application server 150. Application server 150 may be coupled to a storage server 160. Storage server 160 may host a shared, cloud-based file storage platform such as SharePoint or One Drive for Business. To that end, storage server 160 may include database 170 stored in memory. Alternatively, storage server 160 may be communicatively coupled to one or more separate and distinct database servers (not shown) maintaining database 170 and executable instructions associated with managing the database (e.g., performing lookups and, in some embodiment, generating secure HTML links to data files as discussed below). A client 180 may be communicatively coupled to both target platform 130 and storage server 160. Another client 190 may be communicatively coupled to network server 140 for the purpose of accessing the network-based solution hosted by application server 150. Some or all of the foregoing devices may function together as a system over network 120.

Source email platform 110 and target email platform 130 may each be a cloud-based or hosted email platforms, some examples of which include Google Apps Gmail™, SunONE/iPlanet™, Novell GroupWise™, Microsoft Exchange 2000/2003/2007/2010™, Microsoft BPOS™, Microsoft Live@edu™, and Microsoft 365™. Source platform 110 and target platform 130 may each include one or more computing devices, such as network servers and mail servers, communicatively coupled together to form a self-contained hosted email system. As noted above, in some embodiments concerning archiving operations, target email platform 130 not be necessary. In some cases, for instance, large files may be processed at source email platform 110 and then returned to source email platform 110 in modified form as part of the archiving process.

Network 120 may be implemented as a private network, a public network, an intranet, the Internet, or any suitable combination of the foregoing. Although FIG. 1 illustrates certain computing devices communicatively coupled to network 120 (i.e., source platform 110, target platform 130, and network server 140) persons of ordinary skill in the art will readily recognize and appreciate that all of the devices depicted in FIG. 1 may be communicatively coupled together through network 120 or a series of such networks.

Network server 140 may receive and respond to requests transmitted over network 120 between the various computing devices depicted in FIG. 1 (e.g., between client 190 and application server 150. Although network server 140 is depicted between client 190 and application server 150 in FIG. 1, persons of ordinary skill in the art will appreciate that the environment illustrated in FIG. 1 may in many cases include additional network servers between other computing devices and may implement a network service. In one embodiment, for example, network 120 may be the Internet and network server 140 may be a web server. In various possible embodiments, network server 120 and application server 140 may be incorporated into a single computing device or, alternatively, may function as standalone computing devices as illustrated in FIG. 1.

Application server 150 may communicate with multiple computing devices, including for example network server 140, target email platform 130, storage server 160, and client 190. Application server 150 may host and maintain an executable application in memory. When executed, the application may provide a network-based solution for automatically processing large email attachments during migration and archiving operations involving source email platform 110 and, in the case of migration operations, target email platform 130. As noted above, network server 140 and application server 150 may be incorporated as a single computing device or, alternatively, they may function as standalone computing devices.

Storage server 160 may communicate with application server 150, database 170, and client 180. In some embodiments, storage server 160 may be incorporated into a single computing device with either or both of network server 140 and application server 150. Database 170 may store data, process data, and resolve queries received from storage server 160.

Clients 180 and 190 may each be a computing device, such as a desktop computer, workstation, laptop, smartphone, tablet, or other suitable computing device. Clients 180 and 190 may each be communicatively coupled to network 120 at a network interface and may each be coupled either directly to network 120 or through any number of intermediate network servers, gateways, or other suitable computing devices. Client 180 may include a locally stored client email application and may be associated with an email user. The email user may be a standard user of source platform 110 and may be associated with a mailbox being migrated over network 120 from source platform 110 to target platform 130. Provided the benefit of the network-based solution described herein, client 180 may not only communicate with target platform 130 following migration, but also with storage server 160 as necessary to retrieve or otherwise access large email attachments that were automatically detected and migrated to storage server 160 by the application hosted on application server 150.

Client 190 may include a network browser application through which a user, such as a company's system administrator, may access network-based applications. The network browser may be a locally stored client application such as Chrome, FireFox, Safari, Opera, or Internet Explorer. The network browser may permit an administrator to view content provided to client 190 by application server 150. In some embodiments, client 190 may be a mobile device and, rather than viewing content provided to client 190 with a network browser application, administrator may do so through a custom mobile application downloaded and locally installed on client 190. In any event, through a series of graphical user interfaces rendered and displayed at client 190, the administrator may communicate with application server 150 to configure, deploy, and monitor the executable application stored in memory of application server 150. Notably, in some instances, client 180 and 190 may be the same computing device, just as the administrator may be both an administrator and a user of source email platform 110.

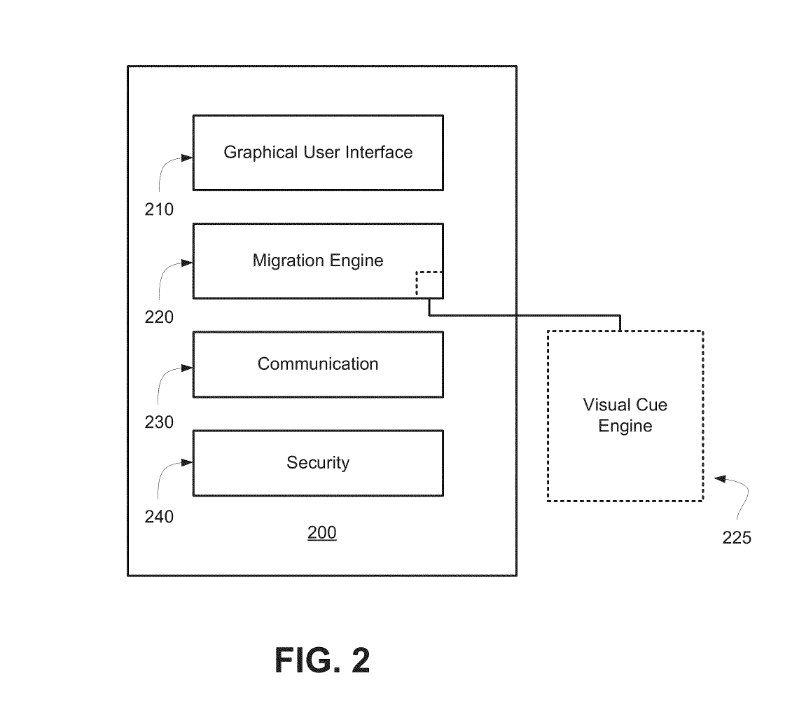

FIG. 2 is a block diagram of an exemplary application 200 stored in memory of application server 150. Application 200 may include a plurality of objects or modules, each of which may be responsible for effectuating one or more functionalities that contribute to the provision of a network-based solution for automatically processing large email attachments or other large files during migration and archiving operations. Each module may include a data model associated with a particular functionality and executable computer instructions that, when executed, effectuate the functionality.

As shown in FIG. 2, application 200 may include a graphical user interface module 210, a migration engine 220, a communication module 230, and a security module 240. Graphical user interface module may include executable instructions that, when executed by a processor of application server 150, effectuate functionality concerning the render and display of a series of graphical user interfaces on clients 180 or 190. Migration engine 220 may include executable instructions that, when executed by a processor of application server 150, effectuate functionality concerning the automatic detection, processing, and migration of large email attachments originating from source platform 110. Although FIG. 2 illustrates engine 220 as a migration engine, persons of ordinary skill in the art will readily appreciate that engine 220 may likewise be an archiving engine when the solution is applied within the archiving context. Thus, for purposes of the present disclosure, it should be understood that any references to migration engine may likewise refer to archiving engine 220 within the appropriate embodiment (e.g., within the archiving context).

Migration engine 220 may include, as a sub-module, visual cue engine 225. Visual cue engine 225 may include executable instructions that, when executed by a processor of application server 150, effectuate functionality concerning the automatic generation of a visual cue of the detected attachment (e.g., an iconic representation, a thumbnail image, or a video clip). Visual cue engine 225 may be a sub-module of migration engine 220, or it may be a separate and distinct module of application 200. Visual cue engine 225 may also be a separate and distinct application. Visual cue engine 220 may be stored in and executed by application server 150 of FIG. 1, or it may be stored in and executed by a separate and distinct computing device.

Communication module 230 may include executable instructions that, when executed by a processor of application server 150, effectuate functionality concerning communications between application server 150 and other computing devices in the exemplary environment depicted in FIG. 1 (e.g., network server 140, target email platform 130, and storage server 160). Security module 240 may include executable instructions that, when executed by a processor of application server 150, effectuate functionality concerning the generation of scrambled or otherwise secure HTML links that provide users direct access to attachments migrated to storage server 160 as discussed below in further detail.

Persons of ordinary skill in the art will readily recognize that the foregoing modules, including migration engine 220, are exemplary in nature and that application 200 may include any number of other modules depending on the anticipated structure of the environment depicted in FIG. 1. Moreover, although exemplary modules have been illustrated as distinct from another, persons of ordinary skill in the art will appreciate that various modules may alternatively be combined. For instance, the functionalities effectuated by communication module 230 and security module 240 may, in some embodiments, be integrated into migration engine 220.

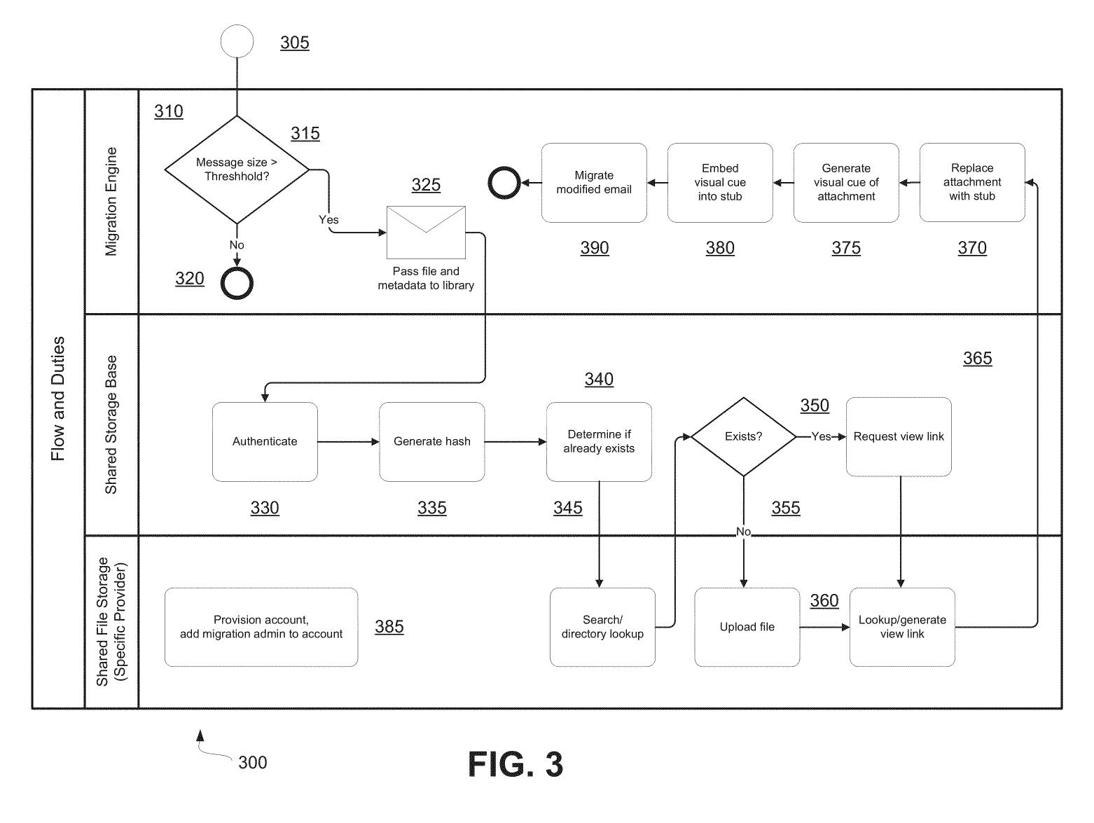

FIG. 3 is a flow diagram of an exemplary method 300 for automatically processing large email attachments or other large files during migration and archiving operations. Exemplary method 300 may be carried out in the context of the environment depicted in FIG. 1 and the exemplary application depicted in FIG. 2.

At block 305, application server 150 may receive from client 190 a plurality of information concerning source email platform 110 and target email platform 130. Application server 150 may receive, for instance, an identification of the server type characterizing source platform 110 (e.g., Microsoft Exchange 2010) and target platform 130 (e.g., Office 365). Application server 150 may also receive domain address information, information concerning any applicable consumer keys and secrets (which may be obtained directly from the respective email platforms by the administrator in many cases), server name information, metadata, and a plurality of administrative login credentials for each email platform (e.g., an admin user name and password).

At block 305, application server 150 may also receive an identification of the mailboxes hosted by source platform 110 that the network-based solution should migrate to target platform 130. Application server 150 may receive the identification in any number of suitable ways, including for example receiving and reading a character-separated values (CSV) file submitted by the administrator at client 190. Alternatively, application server 150 may receive the identification of mailboxes to be migrated through a free-form data entry field presented within a graphical user interface rendered and displayed at client 190.

At block 310, a processor of application server 150 may execute migration engine 220 depicted in application 200 of FIG. 2. Upon execution of migration engine 220, migration engine 220 may use the received administrator login credentials to log into or otherwise access source email platform 110 and download the plurality of mailboxes designated for migration in the identification received at block 305.

At block 315, upon receiving each mailbox designated for migration, migration engine 220 may inspect the mailbox for emails containing attachment files. In one embodiment, migration engine 220 may inspect the mailboxes on a rolling basis as the mailboxes are received from source email platform 110. Employing such an embodiment may be advantageous where the volume of mailboxes designated for migration is high. In other embodiments, migration engine may wait until all of the designated mailboxes have been successfully downloaded before beginning the inspection step.

When migration engine 220 detects an email with an attachment while inspecting a mailbox, migration engine 220 may determine the file size of the attachment by reading metadata associated with the email. At block 315, migration engine 220 may compare the file size of the attachment to a predetermine threshold for attachment sizes. The predetermined threshold may be governed by the predetermined attachment size limit associated with target email platform 130. In a scenario in which target email platform 130 is Office 365, for instance, the predetermined threshold to which migration engine 220 compares the file size of any attachments detected during the inspection process may be equal to the 25 MB attachment size limit that is prebuilt into Office 365. The predetermined threshold may alternatively be set to a size limit even lower than the actual predetermined attachment size limit of target email platform 130.

As illustrated at block 320, when the comparison of the size of an attachment detected during the inspection process to the predetermined threshold determines that the attachment size does not exceed the threshold, migration engine 220 takes no further action with respect to the attachment. In such cases, the email bearing an acceptably sized attachment is ultimately migrated to target email platform 130 with its attachment left in place.

Conversely, at block 325, when the comparison determines that the attachment size exceeds the predetermined threshold, migration engine 220 may upload or otherwise transmit the attachment to storage server 160. Storage server 160 may then securely store the attachment in database 170. Migration engine 220 may then replace the attachment with a “stub” file containing a direct link to the secure attachment stored in database 170 (e.g., an HTML link containing a Universal Naming Convention (UNC) path). The stub may be a word processing document (e.g., a Microsoft Word document) or other file type suitable for transmitting a selectable HTML link that directs users to a platform hosted by storage server 160 in which the replaced attachment is securely stored. Where the stub is a word processing document or other text-based document, the stub file may contain helpful explanatory text in addition to the HTML link. For instance, the stub may be include a custom description of why the original attachment was stripped from the migrated email in addition to including the HTML link itself.

As illustrated at blocks 325 through 370, replacing the attachment with a stub may include a plurality of substeps. In some embodiments, replacing the attachment may include steps performed by visual cue engine 225 of FIG. 2. In the exemplary software architecture shown in FIG. 3, visual cue engine 225 is incorporated within the migration engine 220. In other embodiments, however, visual cue engine 225 may be a distinct routine executed by an independent server communicatively coupled to application server 150. As shown at block 330, replacing the attachment with a stub may include authenticating the file. As shown in the exemplary embodiment of FIG. 3, storage server 160—referred to in FIG. 3 as the “shared storage base”—may perform the authentication after receiving the attachment and associated metadata from application server 150.

At block 335, replacing the attachment may further include generating a hash to be associated with the attachment. In some embodiments, like that shown in FIG. 3, storage server 160 may generate the hash and may use the hash to generate a secure view link. A view link may be an anonymous, unidentifiable, or otherwise secure HTML link containing a UNC path that permits a user of client 180 to read the attachment without providing the user with write or edit permissions. Application server 150 then receives the secure view link and uses it to create a stub file as discussed further below. In other embodiments, application server 150 or a separate computing device may directly create the view link. In such cases, application server 150 may execute security module 240. Security module 240 may, upon execution by a processor of application server 150, create a uniquely scrambled or otherwise secure link by applying hash functions, globally unique identifier (GUID) generation algorithms, a combination of the foregoing, or any other suitable encryption mechanisms.

As depicted at block 340, replacing the attachment may further include determining whether the storage server 160 previously received an upload of the attachment from application server 150. Storage server 160 may do so by determining that the attachment already exists in database 170. At block 345, determining whether the attachment already exists in database 170 may include transmitting a lookup request to database 170 and evaluating a received response to the lookup request. In response to receiving the request for a view link from storage server 160, database 170 may perform a lookup to determine whether a view link was previously generated and stored for the attachment at issue. When the determination indicates that the attachment already exists, as shown at block 350, storage server 160 (or, in some embodiments, application server 150) may refrain from uploading the attachment to storage 160 to avoid spending time and computing resources processing duplicative attachments. Instead, storage server 160 may receive a copy of the view link previously generated for the originally uploaded copy of the attachment. Storage server 160 may then transmit the previously generated view link to application server 150.

In some embodiments, database 170 may be incorporated into storage server 160 as illustrated in FIG. 1. In such cases, storage server 160 may include executable instructions associated with database 170 that, when executed, generate the secure view link. In other embodiments, database 170 may be stored in memory of a distinct computing device communicatively coupled to storage server 160, such as a distinct database, and the distinct computing device may execute instructions that generate the secure view link. In some embodiments, for example in those in which database 170 is stored in memory of a computing device distinct from storage server 60, the computing device storing database 170 may transmit the generated view link directly to application server 150. Persons of ordinary skill in the art will readily recognize that the distribution of functionalities and duties depicted in FIGS. 1-3 and described herein are merely exemplary in nature and that the present disclosure suggests a wide variety of other possible distributions.

When the lookup indicates that storage server 160 did not previously generate a view link, as illustrated at block 360, storage server 160 may proceed with generating a new view link and may transmit the view link to migration engine 220 of application server 150. In some embodiments, storage server 160 may also upload the attachment to database 170 (for instance, where database 170 is stored in a distinct computing device as discussed above) as shown at block 355. Depending on the embodiment, storage server 160 may generate the new view link or a separate computing device maintaining database 170 may do so. Upon receiving the view link from storage server 160 at block 365, migration engine 220 may create a stub file, insert the view link into the stub, and replace the attachment with the stub at block 370.

At block 375, migration engine 220 may generate a visual cue of the attachment. In some embodiments, generating the visual cue may include executing a visual cue engine 225 as discussed above. In such cases, the visual cue provides the user of the target email platform with enhanced contextual information regarding the content of the attachment. The additional information assists the user in quickly determining the content of the attachment and evaluating its relevancy and importance. In doing so, the visual cue functionality helps the user avoid the laborious and time-consuming process of opening and examining each attachment by way of its secure view link. Because the user can directly evaluate the content of the attachment within the confines of the stub file, the visual cue functionality also conserves valuable computing resources that would otherwise be expended opening and displaying each attachment file (e.g., those of the user computing device, the target email platform, the hosted storage platform, and any network devices).

In some instances, the visual cue may be an iconic representation of the file type of the detected attachment. Where the detected attachment is a Microsoft Word™ document, for example, the visual cue may be an iconic representation of the logo commonly associated with the Microsoft Word™ application. In other cases, the visual cue may display at least a portion of the content of the detected attachment. In such cases, the visual cue may in effect provide a preview of the content. The visual cue may be a thumbnail image, video clip, or other visual representation of content. Migration engine 220 may generate the visual cue for each attachment by evaluating metadata associated with, and content contained within, the attachment file. Wherein the visual cue for a video attachment is a thumbnail image, for instance, migration engine 220 (or visual cue engine 225 in embodiments in which the two engines are distinct) may automatically generate a thumbnail image from the first frame of the video. Migration engine 220 may use screen capture techniques or may generate the thumbnail image directly using the underlying image data for the frame at issue.

At block 380, migration engine 220 may embed the visual cue into the stub such that the visual cue is visually associated with the secure view link (i.e., the secure link to the remotely stored copy of the attachment). The visual cue may, for example, be embedded adjacent to the link to create an association between the visual cue and the attachment made available through the view link.

Where the visual cue is a thumbnail image, migration engine 220 may embed the visual cue such that a user computing device of the user will display an enlarged or zoomed view of the thumbnail when the user hovers over or selects the thumbnail through a graphical user interface of the user computing device. Where the visual cue is a video clip, migration engine 220 may embed the visual cue such that the user computing device will display an enlarged or zoomed view of the starting frame when the user hovers over or selects the video clip through the graphical user interface. Where the visual cue is a video clip, migration engine 220 may further embed the visual cue such that the user computing device will effectuate playback of the video clip when the user hovers over or selects the video clip through the graphical user interface. Having modified the email, at block 390 migration engine 220 may transmit the modified or “stubbed” email to target email platform 130 where client 180 may access the email in stubbed form. In embodiments concerning archiving operations, step 390 may include archiving engine 220 transmitting the modified or “stubbed” email or other large file either back to source email platform 110 for continued user access. In such cases, users may not wish to migrate to a new email platform, but rather may wish to continue using source email platform 110 and instead desire to archive aged or infrequently accessed files to reduce disk usage and other computing resources consumed at source email platform 110.

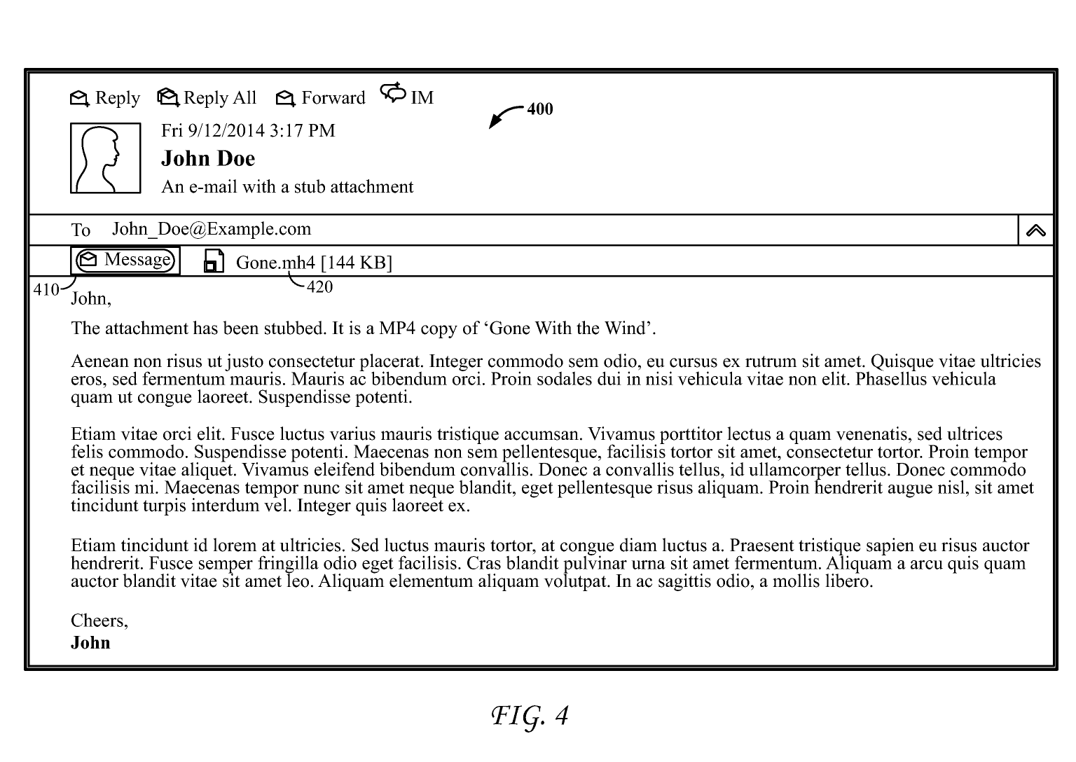

FIG. 4 is an illustration of an exemplary email 400 with a stubbed attachment file. As shown in FIG. 4, email 400 includes a message tab 410 and a stub tab 420. When selected by the user of client 180 accessing target email platform 130 (or source email platform 110 in the context of archiving operations), message tab 410 displays the body of the email message along with a notification that the file formerly attached to the email was stubbed.

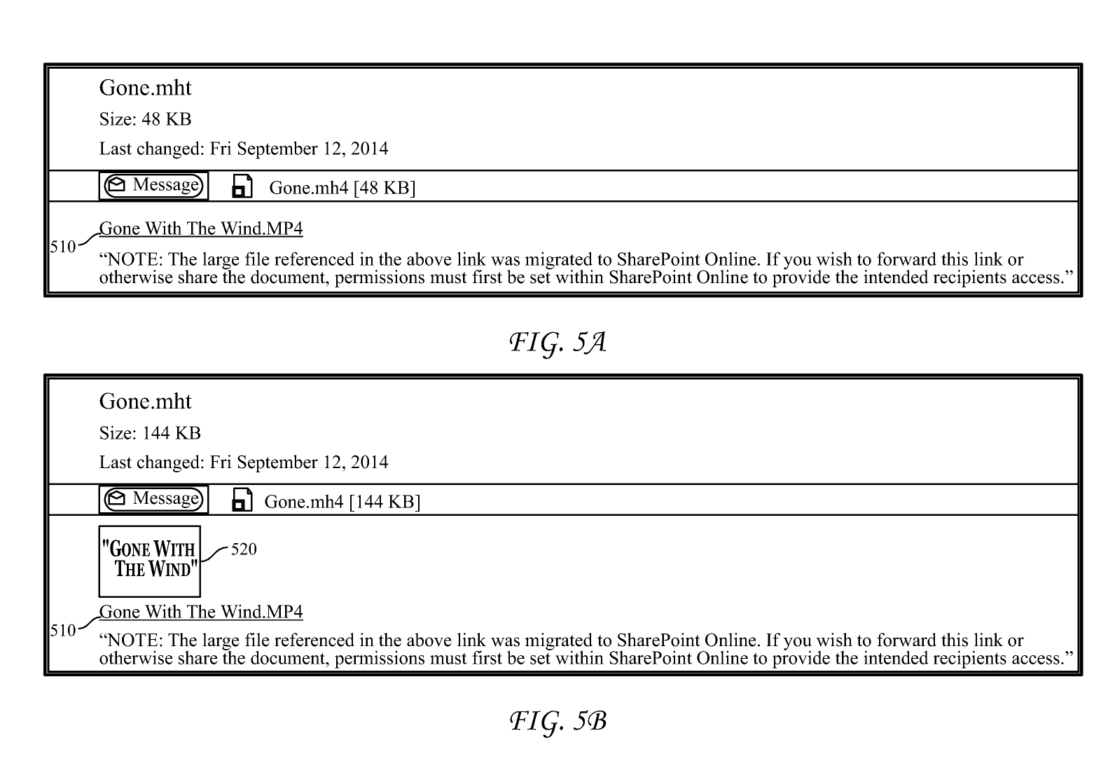

FIGS. 5A and 5B respectively illustrate the stub tab 420 of exemplary email 400 of FIG. 4 both with and without an embedded visual cue of the content contained in the stubbed attachment file. When selected, stub tab 420 of FIG. 4 displays the stub with which migration engine 220 (or archiving engine 220 in embodiments concerning archiving operations) replaced the former attachment file. As shown in the exemplary stub 420 of FIG. 5A, stub 420 displays a view link indicating the file name of the remotely stored attachment file. In FIG. 5B, in contrast, stub 420 displays both a view link indicating the file name of the remotely stored attachment file and a visual cue 520 of the content of the attachment file.

In the exemplary context of FIG. 5B, the visual cue is a thumbnail image displaying the title frame of the film “Gone With the Wind.” In other examples, visual cue 520 may alternatively display a frame other than the first frame or title frame, such as a highly recognized scene from the film. Visual cue 520 may also be a video clip of the film that may play for the user. The video clip may play immediately when the stub tab is selected, or it may only play when the user, by way of the graphical user interface, hovers over or selects visual cue 520 with a cursor (or finger, stylus, or other selection tool, in the case of a touchscreen device).

By providing visual cue 520 as shown in FIG. 5B, the network-based solution described herein enhances the user's ability to efficiently analyze the content of attachments that have been remotely stored or “stubbed” during the migration or archiving operation.

When migration engine 220 receives a previously generated view link from storage server 160 in response to a lookup performed at database 170, it may create the stub, insert the previously generated view link into the stub, embed the visual cue into the stub, and replace the attachment with the stub as described above.

In some instances, in lieu of a view link that effectively directs the user of client 180 to a read-only version of the attachment removed from the email and stored in storage server 160, migration engine 220 may insert a link to a version of the attachment that permits full read and write privileges. The view link method, however, provides an added layer of security by ensuring that migrated or archived email attachments retain their association with the original document rather than becoming associated with an edited version that may not accurately reflect what was migrated. In embodiments utilizing view links, the network-based solution for processing large attachments or other large files during migration and archiving operations may offer even greater data fidelity.

Referring back to FIG. 3, at block 385, storage server 160 may provision a new user account within the shared storage platform hosted by storage server 160 (or by a distinct computing device storing database 170, where applicable) for the user of client 180. As a result, the user of client 180 may appropriately access the attachment preserved in the shared storage platform of storage server 160. To ensure that the administrator at client 190 may appropriately manage the migration or archiving operation, storage server 160 may add the administrator to the new account. Where storage server 160 determines that the user of client 180 is already associated with a registered account for the shared storage platform, storage server 160 may simply grant the existing account access to any uploaded attachments originating from emails within a migrated or archived mailbox associated with that particular user.

Following the above process, migration engine 220 may complete the migration process for the email at issue by transmitting the stubbed email to client 180 by way of target email platform 130 (or back to source email platform 110 in the case of some embodiments concerning archiving operations). The user of client 180 may then access the stubbed email via client 180. In accessing the stubbed email via client 180, the user may view the visual cue embedded in the stubbed email to determine the relevancy or importance of any attachment that migration engine 220 replaced with a stub. Upon selecting the secure view link contained in the attached stub (and reading any accompanying explanatory text), the user may be directed to the original attachment as preserved within the shared storage platform hosted by storage server 160, which as illustrated in FIG. 1 may include database 170. In some embodiments, the visual cue may itself serve as the selectable view link. In such cases, the user may simply select the visual cue to access the remotely stored attachment.

In some embodiments, application server 150 may upload to storage server 160 a separate copy of the attachment for each recipient in an address list of a migrated email. In other embodiments, application server 150 may upload a single copy of the attachment to hosted server 160. In such cases, application server 150, storage server 160, or a combination of the foregoing may actively manage ownership and rights information so as to provide each recipient in the address list of the migrated or archived email appropriate access to the single attachment file.

As is clear from the above description, a network-based solution for automatically processing large email attachments or other large files during migration and archiving operations, as may be embodied by various systems and methods, has been disclosed. The foregoing methods may be performed by an executable computer program (e.g. application 200 of FIG. 2) embodied on a non-transitory computer-readable storage medium.

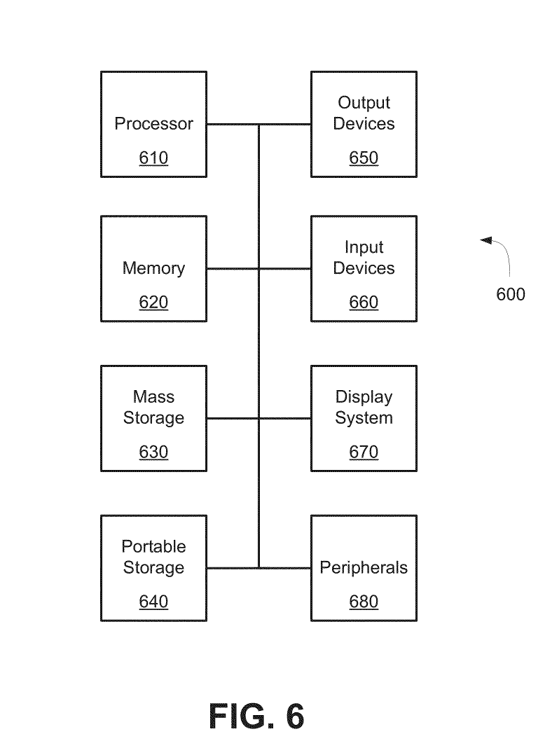

FIG. 6 is a block diagram of an exemplary system for implementing a computing device. The system 600 of FIG. 6 may be implemented in the context of clients 180 and 190, communication network 120, network server 140, application server 150, storage server 160, and database 170 of FIG. 1. The computing system of FIG. 6 may include one or more processors 610 and memory 620. Main memory 620 may store, in part, instructions and data for execution by processor 610. Main memory 620 may store the executable code when in operation. Computing system 600 may further include a mass storage device 630, a portable storage medium drive 640, output devices 650, user input devices 660, a graphics display system 670, and peripheral devices 680.

The components shown in FIG. 6 are depicted as being connected via a single bus 690. The components may alternatively be connected through one or more data transport means. Processor 610 and main memory 620, for example, may be connected via a local microprocessor bus. Mass storage device 630, peripheral device(s) 680, portable storage device 640, and display system 670 may be connected via one or more input/output buses.

Mass storage device 630, which may be implemented with a magnetic disk drive or an optical disk drive, may be a non-volatile storage device for storing data and instructions for use by processor 610. Mass storage device 630 may store system software for implementing embodiments of the network-based solution described herein for purposes of loading the software into main memory 620.

Portable storage device 640 may operate in conjunction with a portable non-volatile storage medium, such as a compact disk or digital video disc, to input and output data and code to and from computer system 600. The system software for implementing embodiments of the present network-based solution may be stored on such a portable medium and input to computer system 600 via portable storage device 640.

Input devices 660 may provide a portion of a user interface. Input devices 660 may include an alpha-numeric keypad, such as a keyboard, touch screen, or touchpad, for inputting alpha-numeric and other information, or a pointing device, such as a mouse, a trackball, stylus, or cursor direction keys. Additionally, system 600 may include output devices 650, such as speakers, printers, network interfaces, monitors, and the like.

Display system 670 may include a liquid crystal display or other suitable display device. Display system 670 may receive textual and graphical information and may process the information for output to the display device.

Peripherals 680 may include any type of computer support device to add additional functionality to computer system 600. Peripheral device 680 could be, for example, a modem or a router.

The components illustrated in computer system 600 of FIG. 6 are those typically found in computer systems that may be suitable for use with embodiments of the present network-based solution. The depiction of such components is not intended to be exhaustive in nature, but is rather intended to represent a broad category of computer components that are well known in the art. Thus, system 600 may be a desktop computer, workstation, server, mainframe computer, laptop, tablet, smartphone or other mobile or hand-held computing device, or any other suitable computing device. Computer system 600 may also include various bus configurations, networked platforms, multi-processor platforms, etc. Various operating systems may be used, such as Unix, Linux, Windows, Macintosh OS, Palm OS, and other suitable operating systems.

The network-based solution described herein constitutes a novel, substantial, and meaningful improvement to the technical processes of automated email migration between hosted email platforms and automated archiving operations. By automatically detecting impermissibly large email attachments or other large files during migration and archiving operations and replacing the attachments with permissibly sized stub files, the solution overcomes many of the failures plaguing migration and archiving operations today. By automatically inspecting every mailbox (or a designated subset of mailboxes) in a source platform, securely storing any detected email attachments over a particular size, and modifying the emails to avoid errors during migration and archiving operations, the solution provides feasible and practical utility for platforms with high volumes of users, including those used on enterprise-level scales. By uploading the original attachment file to a secure, shared storage platform and providing a link to the location of the stored attachment in the stub file, the solution significantly enhances data fidelity and permits users to quickly and reliably access attachments that would have otherwise been lost during a conventional migration or archiving process.

Moreover, by utilizing a word processing document format for the stub file, the solution permits an administrator to include explanatory text along with the link to the hosted file (e.g., a helpful introduction to the shared file storage platform hosted by the storage server). In doing so, the solution helps to avoid confusion that might otherwise be experienced by the email user upon opening a migrated or archived email and discovering that an attachment is no longer present. The solution also provides enhanced security benefits by providing uniquely scrambled or otherwise secured links that cannot simply be guessed by trial and error or otherwise identified.

Embedding a visual cue of the content of any remotely stored and stubbed attachment files provides the user with even greater enhanced contextual information concerning the attachment. The additional context assists the user in quickly determining the content of the attachment and evaluating its relevancy and importance. By extension, the visual cue functionality helps the user avoid the laborious and time-consuming process of opening and examining each attachment by way of its secure view link. Because the user can directly evaluate the content of the attachment within the confines of the stub file, the visual cue functionality also conserves valuable computing resources that would otherwise be expended opening and displaying each attachment file.

As noted above, although the foregoing description discusses migration between email platforms at length, in other embodiments the network-based solution provides for automatic processing of large files during migration between other types of platforms, such as enterprise social networking platforms (e.g., from Jive to Yammer). The solution further provides the same functionality within the context of archiving operations. All of the benefits over the prior art provided by the solution and described above are equally applicable to such alternative embodiments. The foregoing detailed description has been presented for purposes of illustration and description. It is not intended to be exhaustive or to limit the technology to the precise form disclosed (e.g., only as applied to migrations between email platforms or other platforms, such as enterprise social networking platforms, or only as applied to archiving operations). Many modifications and variations are possible in light of the above teaching. The described embodiments were chosen in order to best explain the principles of the technology and its practical application to enable others skilled in the art to best utilize the technology in various embodiments and with various modifications as suited to the particular use contemplated. It is intended that the scope of the technology be defined by the claims appended hereto.

What is claimed is:

1. A system for automatically processing large email attachments during migration and archiving operations, the system comprising:
a first email platform hosted by a first computing device, the first email platform storing a plurality of mailboxes, each mailbox including a plurality of emails;
a storage server; and
an application server communicatively coupled to the first email platform and the storage server by a network, the application server having stored in memory a predetermined attachment size limit and an executable application that, when executed by a processor of the application server:
downloads the mailboxes from the first email platform,
inspects each downloaded mailbox for an email containing an attachment file,
determines a file size of a detected attachment file,
compares the file size of the detected attachment file to the predetermined attachment size limit stored in memory,
uploads a copy of the detected attachment to the storage server to be stored in memory when the comparison determines that the file size of the detected attachment file exceeds the predetermined attachment size limit stored in memory,
generates a visual cue of the detected attachment,
modifies the email by:
replacing the detected attachment in the email with a link to the copy of the detected attachment stored at the storage server, and
embedding the generated visual cue into the email, and
transmits the modified email to at least one of the first email platform and a second email platform hosted by a second computing device communicatively coupled to the network.

2. The system of claim 1, further including a database associated with the storage server, the database storing the copy of the detected attachment.

3. The system of claim 1, wherein the storage server provisions a user account for each user associated with one of the mailboxes stored in the first email platform.

4. The system of claim 2, wherein the application server uploads a separate copy of the detected attachment to the storage server for each user listed in a recipient line of the inspected email.

5. The system of claim 2, wherein the application server uploads a single copy of the detected attachment to the storage server and the storage server grants access to one or more users listed in the recipient line of the inspected email in accordance with certain predetermined permissions information.

6. The system of claim 1, wherein determining the file size of the detected attachment file includes reading metadata associated with the attachment file.

7. The system of claim 1, wherein the application server downloads and inspects the mailboxes on a rolling basis as the mailboxes are received from the first email platform.

8. The system of claim 1, wherein the application server inspects the mailboxes after all of the mailboxes designated for download have been successfully received from the first email platform.

9. The system of claim 1, wherein the predetermined attachment size limit is automatically determined by an attachment size limit built into at least one of the first email platform and the second email platform.

10. The system of claim 1, wherein the predetermined attachment size limit is custom determined by an administrator.

11. The system of claim 1, wherein replacing the detected attachment in the email with a link to the copy of the detected attachment stored at the storage server includes generating a stub file.

12. The system of claim 11, wherein replacing the detected attachment in the email with a link to the copy of the detected attachment stored at the storage server further includes inserting the link into the stub file, removing the detected attachment, and attaching the stub file in place of the removed attachment.

13. The system of claim 11, wherein the stub file is a word processing document.

14. The system of claim 11, wherein the stub file contains text in addition to the link.

15. The system of claim 1, wherein the link is an HTML link containing a UNC path that points to the location of the uploaded copy of the detected attachment stored in the storage server.

16. The system of claim 1, wherein the link is a view link that permits a user to read the uploaded copy of the detected attachment without permitting the user to write to or edit the copy of the detected attachment.

17. The system of claim 1, wherein the visual cue of the detected attachment is an iconic representation of the file type of the detected attachment.

18. The system of claim 1, wherein the visual cue of the detected attachment displays at least a portion of the content of the detected attachment.

19. The system of claim 18, wherein the visual cue of the detected attachment is a thumbnail image.

20. The system of claim 18, wherein the visual cue of the detected attachment is a video clip.

21. The system of claim 20, wherein the video clip only plays when hovered over or selected by a user of the second email platform through a graphical user interface of a user computing device.

22. A method for automatically processing large email attachments during migration and archiving operations, the method comprising:
downloading from a first email platform a plurality of mailboxes, each mailbox including a plurality of emails; and
executing instructions stored in memory, wherein execution of the instructions:
inspects each downloaded mailbox for an email containing an attachment file,
determines a file size of a detected attachment file,
compares the file size of the detected attachment file to a predetermined attachment size limit,
uploads a copy of the detected attachment to a storage server for storage when the comparison determines that the file size of the detected attachment file exceeds the predetermined attachment size limit,
generates a visual cue of the detected attachment,
modifies the email by:
replacing the detected attachment in the email with a link to the copy of the detected attachment stored at the storage server, and
embedding the generated visual cue into the email, and
transmitting the modified email to at least one of a the first email platform and a second email platform hosted by a second computing device communicatively coupled to the network.

23. The method of claim 22, wherein uploading the copy of the detected attachment to the storage server includes uploading a separate copy of the detected attachment to the storage server for each user listed in a recipient line of the inspected email.

24. The method of claim 22, wherein uploading the copy of the detected attachment to the storage server includes uploading a single copy of the detected attachment to the storage server to be rights managed by the storage server according to the certain predetermined permissions information.

25. The method of claim 22, wherein determining the file size of the detected attachment file includes reading metadata associated with the attachment file.

26. The method of claim 22, wherein the step of inspecting the mailboxes is performed on a rolling basis as the mailboxes are downloaded from the first email platform.

27. The method of claim 22, wherein the step of inspecting the mailboxes is performed after all of the mailboxes designated for download have been successfully received from the first email platform.

28. The method of claim 22, wherein the predetermined attachment size limit is automatically determined by an attachment size limit built into the second email platform.

29. The method of claim 22, wherein the predetermined attachment size limit is custom determined by an administrator.

30. The method of claim 22, wherein replacing the detected attachment in the email with a link to the copy of the detected attachment stored at the storage server includes generating a stub file.

31. The method of claim 30, wherein replacing the detected attachment in the email with a link to the copy of the detected attachment stored at the storage server further includes inserting the link into the stub file, removing the detected attachment, and attaching the stub file in place of the removed attachment.

32. The method of claim 30, wherein the stub file is a word processing document.

33. The method of claim 30, wherein the stub file contains text in addition to the link.

34. The method of claim 22, wherein the link is an HTML link containing a UNC path that points to the location of the uploaded copy of the detected attachment stored in the storage server.

35. The method of claim 22, wherein the link is a view link that permits a user to read the uploaded copy of the detected attachment without permitting the user to write to or edit the copy of the detected attachment.

36. The method of claim 22, wherein the visual cue of the detected attachment is an iconic representation of the file type of the detected attachment.

37. The method of claim 22, wherein the visual cue of the detected attachment displays at least a portion of the content of the detected attachment.

38. The method of claim 37, wherein the visual cue of the detected attachment is a thumbnail image.

39. The method of claim 37, wherein the visual cue of the detected attachment is a video clip.

40. The method of claim 39, wherein the video clip only plays when hovered over or selected by a user of the second email platform through a graphical user interface of a user computing device.

41. A non-transitory computer-readable storage medium having embodied thereon a computer program executable by a processor to perform a method for automatically processing large email attachments during migration and archiving operations, the method comprising:
downloading from a first email platform a plurality of mailboxes, each mailbox including a plurality of emails;
inspecting each downloaded mailbox for an email containing an attachment file;
determining a file size of a detected attachment file;
comparing the file size of the detected attachment file to a predetermined attachment size limit;
uploading a copy of the detected attachment to a storage server for storage when the comparison determines that the file size of the detected attachment file exceeds the predetermined attachment size limit;
generating a visual cue of the detected attachment;
embedding the generated visual cue into the email;
modifying the email by replacing the detected attachment in the email with a link to the copy of the detected attachment stored at the storage server; and
transmitting the modified email to the at least one of the first email platform and a second email platform hosted by a second computing device communicatively coupled to the network.
